(19) United States
(12) Patent Application Publication
(10) Pub. No.: US 2024/0384985 A1
(43) Pub. Date: Nov. 21, 2024

(54) THREE-DIMENSIONAL SHAPE MEASUREMENT APPARATUS, CONTROL METHOD, AND NON-TRANSITORY COMPUTER-READABLE RECORDING MEDIUM

(71) Applicant: Konica Minolta, Inc., Tokyo (JP)

(72) Inventors: Sotaro YOKOTA, Tokyo (JP); Masayuki IIJIMA, Okazaki-shi (JP); Yoshihiro INAGAKI, Tokyo (JP)

(21) Appl. No.: 18/656,743

(22) Filed: May 7, 2024

(30) Foreign Application Priority Data
May 18, 2023 (JP) 2023-082011

(51) Int. Cl. G01B 11/25

(52) U.S. Cl. CPC G01B 11/2504

(57) ABSTRACT

A three-dimensional shape measurement apparatus includes: a camera adjusted to bring a measurement target into focus; and a projector that projects a stripe pattern. A cycle of the stripe pattern projected by the projector is variable.

### CROSS-REFERENCE TO RELATED APPLICATIONS

The present invention claims priority under 35 U.S.C. § 119 to Japanese Patent Application No. 2023-082011, filed on May 18, 2023, is incorporated herein by reference in its entirety.

### BACKGROUND

### Technological Field

The present disclosure relates to a three-dimensional shape measurement apparatus, a control method, and a non-transitory computer-readable recording medium.

### Description of the Related Art

Conventionally, an apparatus that measures a three-dimensional shape using a principle of a phase shift method (hereinafter referred to as a “three-dimensional shape measurement apparatus”) has been developed (see, for example, Japanese Laid-Open Patent Publication No. 2013-88261, Japanese Laid-Open Patent Publication No. 2016-31284, Japanese Laid-Open Patent Publication No. 2021-85797 and Japanese Laid-Open Patent Publication No. 2005-214653). The three-dimensional shape measurement apparatus using the phase shift method includes: a projector that projects a light pattern on a measurement target; and a camera that captures an image of the measurement target on which the light pattern is projected. Normally, a range of distance between the three-dimensional shape measurement apparatus and the measurement target is restricted depending on a focal length of an optical system of the projector and a focal length of an optical system of the camera. Therefore, in general, when a user wants to measure a plurality of types of measurement targets at different distances from the three-dimensional shape measurement apparatus, the user needs to selectively use a plurality of types of three-dimensional shape measurement apparatuses.

Japanese Laid-Open Patent Publication No. 2018-146521 discloses an apparatus including a projection section that can project pattern light by subjecting parallel light to optical scanning in order to handle a wide range of distance to a measurement target.

### SUMMARY

However, according to the apparatus described in Japanese Laid-Open Patent Publication No. 2018-146521, it takes a long measurement time to perform measurement in the wide range because the parallel light is subjected to raster-scanning.

An object of the present disclosure is to provide a three-dimensional shape measurement apparatus, a control method, and a non-transitory computer-readable recording medium so as to handle a wide range of distance to a measurement target while suppressing an increase in measurement time.

To achieve at least one of the abovementioned objects, according to an aspect of the present invention, a three-dimensional shape measurement apparatus reflecting one aspect of the present invention comprises: a camera adjusted to bring a measurement target into focus; and a projector that projects a stripe pattern. A cycle of the stripe pattern projected by the projector is variable.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram schematically illustrating an exemplary system to which a three-dimensional shape measurement apparatus according to an embodiment is applied.

FIG. 2 is a diagram illustrating an exemplary hardware configuration of the three-dimensional shape measurement apparatus according to the embodiment.

FIG. 3 is a diagram illustrating an exemplary stripe pattern generated by a light modulation apparatus.

FIG. 4 is a diagram illustrating luminance values and phase shift amounts of pixels in four captured images corresponding to phase shift amounts of 0, π/2, π, and 3π/2.

FIG. 5 is a diagram illustrating an influence of a luminance error over three-dimensional shape measurement.

FIG. 6 is a diagram illustrating an exemplary captured image when degrees of focus of a projection optical system and a light-collection optical system on the measurement target are changed.

FIG. 7 is a diagram illustrating changes in contrast of the stripe pattern in the captured image and conversion accuracy from a phase φ to a height h with respect to a spatial frequency of the stripe pattern.

FIG. 8 is a diagram illustrating an exemplary table.

FIG. 9 is a diagram illustrating a first setting method for a cycle candidate.

FIG. 10 is a diagram illustrating a second setting method for a cycle candidate.

FIG. 11 is a diagram illustrating a third setting method for a cycle candidate.

FIG. 12 is a flowchart illustrating a flow of a method of controlling the projector by a processor.

FIG. 13 is a diagram illustrating a hardware configuration of a three-dimensional shape measurement apparatus according to a modification example 1.

FIG. 14 is a diagram illustrating a hardware configuration of a three-dimensional shape measurement apparatus according to a modification example 2.

FIG. 15 is a diagram illustrating an exemplary captured image.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, embodiments and modification examples according to the present disclosure will be described with reference to figures. In the description below, the same components and constituent elements are denoted with the same reference signs. Their names and functions are the same. Therefore, detailed description thereof will not be repeated. Note that the embodiments and modification examples described below may be selectively combined as appropriate.

### <Exemplary Application of Three-Dimensional Shape Measurement Apparatus>

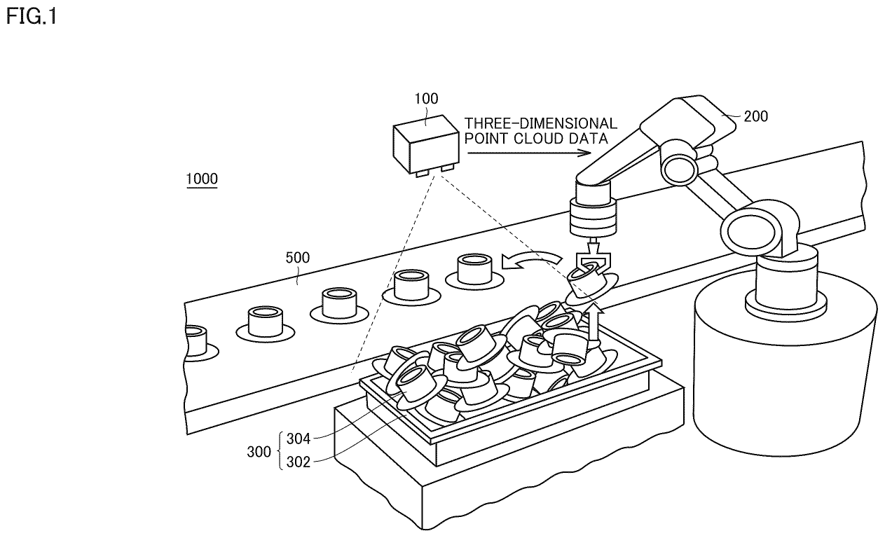

FIG. 1 is a diagram schematically illustrating an exemplary system to which a three-dimensional shape measurement apparatus according to an embodiment is applied. A system 1000 includes a three-dimensional shape measurement apparatus 100 and a robot 200.

Three-dimensional shape measurement apparatus 100 measures a three-dimensional shape of a measurement target 300 using a principle of a phase shift method. The measurement target 300 includes a tray 302 and a plurality of workpieces 304 placed in bulk on the tray 302. Three-dimensional shape measurement apparatus 100 outputs, to the robot 200, data (hereinafter, referred to as “three-dimensional point cloud data”) indicating the measured three-dimensional shape.

Based on the three-dimensional point cloud data received from the three-dimensional shape measurement apparatus 100, the robot 200 determines a workpiece 304 to be grasped and performs a pick-and-place operation for the workpiece 304 to be grasped. Specifically, the robot 200 grasps a workpiece 304 on the tray 302 and places the workpiece 304 on a conveyance belt 500.

Note that the system to which the three-dimensional shape measurement apparatus 100 is applied is not limited to the system 1000 illustrated in FIG. 1. The three-dimensional shape measurement apparatus 100 is used for various purposes of use.

### <Configuration of Three-Dimensional Shape Measurement Apparatus>

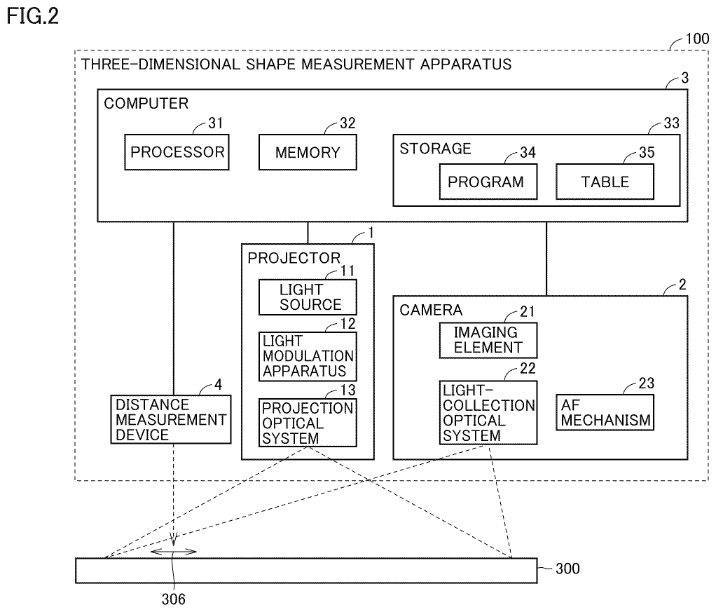

FIG. 2 is a diagram illustrating an exemplary hardware configuration of the three-dimensional shape measurement apparatus according to the embodiment. As illustrated in FIG. 2, the three-dimensional shape measurement apparatus 100 includes a projector 1, a camera 2, a computer 3, and a distance measurement device 4.

The projector 1 includes a light source 11, a light modulation apparatus 12, and a projection optical system 13. A light flux emitted from the light source 11 is modulated by the light modulation apparatus 12 and is projected on the measurement target 300 via the projection optical system 13.

The light source 11 includes, for example, a light emitting diode (LED), an ultra-high pressure mercury lamp, or a halogen lamp. The light source 11 emits white light.

The light modulation apparatus 12 modulates the light from the light source 11 to generate a projection image. The light modulation apparatus 12 includes, for example, a digital micromirror device (DMD). In the present embodiment, the light modulation apparatus 12 can generate a stripe pattern as the projection image.

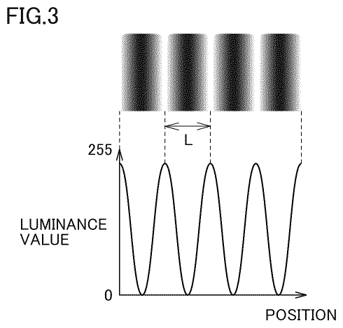

FIG. 3 is a diagram illustrating an exemplary stripe pattern generated by the light modulation apparatus. A luminance distribution of the stripe pattern is illustrated in the upper part of FIG. 3. A graph in which the horizontal axis represents a position, and the vertical axis represents a luminance value is illustrated in the lower part of FIG. 3. As illustrated in the graph, the luminance value is changed in the form of a sinusoidal wave in accordance with a position. The light modulation apparatus 12 changes a cycle L of the stripe pattern in accordance with control from the computer 3. That is, the cycle L of the stripe pattern projected by the projector 1 is variable.

The projection optical system 13 projects, on the measurement target in an enlarged manner, the projection image generated by the light modulation apparatus 12. The projection optical system 13 has one or more lenses. The projection optical system 13 does not have an auto-focus function. Therefore, the projector 1 has a fixed focal length.

Returning to FIG. 2, the camera 2 captures an image of the measurement target and generates image data (hereinafter, referred to as a “captured image”). The camera 2 includes an imaging element 21, a light-collection optical system 22, and an auto-focus (AF) mechanism 23.

The imaging element 21 converts, into an electric signal, an intensity of light obtained through the light-collection optical system 22. The imaging element 21 includes, for example, a charge coupled device (CCD) or a complementary metal-oxide-semiconductor (CMOS).

The light-collection optical system 22 is an optical system for collecting light coming from outside, and typically has one or more lenses.

The auto-focus mechanism 23 controls the position of the light-collection optical system 22 so as to bring the measurement target into focus. The camera 2 is adjusted by the auto-focus mechanism 23 so as to bring the measurement target 300 into focus.

The distance measurement device 4 measures a distance to the measurement target 300. The distance measurement device 4 is disposed at the same height as that of the projector 1. Therefore, the distance measurement device 4 measures a distance between the projector 1 and the measurement target 300. Hereinafter, the distance measured by the distance measurement device 4 is referred to as a “measurement distance”. The distance measurement device 4 is constituted of, for example, a millimeter-wave sensor or the like that can measure a distance in a short period of time. However, the distance measurement device 4 is not limited thereto, and may be constituted of a known distance measurement sensor.

The distance measurement device 4 may measure, for example, a distance to a partial range 306 of the measurement target 300. Since the measurement range is restricted, the distance measurement device 4 can measure the measurement distance in a short period of time. The partial range 306 has a length corresponding to one cycle of the stripe pattern projected on the measurement target 300, for example.

The computer 3 controls the projector 1, the camera 2, and the distance measurement device 4. The computer 3 includes a processor 31, a memory 32, and a storage 33.

The processor 31 is a hardware processor constituted of, for example, a central processing unit (CPU), a micro-processing unit (MPU), or the like. The memory 32 is constituted of, for example, a volatile storage device such as a dynamic random access memory (DRAM) or a static random access memory (SRAM). The storage 33 is constituted of, for example, a nonvolatile storage device such as a hard disk drive (HDD), a solid state drive (SSD), or a flash memory.

The storage 33 stores a program 34. The program 34 includes a computer-readable instruction for controlling each of the projector 1, the camera 2, and the distance measurement device 4. The processor 31 controls the projector 1, the camera 2, and the distance measurement device 4 by executing the program 34, thereby implementing various types of processing according to the present embodiment.

The program 34 may be incorporated in a part of an appropriate program and provided, rather than a single program. In this case, the processing according to the present embodiment is implemented in cooperation with the appropriate program. Such a program that does not include a part of modules is not deviated from the gist of the three-dimensional shape measurement apparatus 100 according to the present embodiment. Further, part or all of the functions provided by the program 34 may be implemented by dedicated hardware.

The storage 33 further stores a table 35. The table 35 is used to control the cycle L of the stripe pattern projected by the projector 1.

### <Phase Shift Method>

The processor 31 measures the three-dimensional shape of the measurement target 300 using, for example, the principle of the phase shift method disclosed in Japanese Laid-Open Patent Publication No. 2005-214653. Specifically, the processor 31 controls the projector 1 to project the stripe pattern while shifting the phase. The processor 31 acquires from the camera 2, a plurality of captured images corresponding to a plurality of phase shift amounts of the stripe pattern. For example, the processor 31 acquires four captured images when the phase shift amounts are 0, π/2, π, and 3π/2.

The luminance value of each pixel in the plurality of captured images is expressed by the following formula (1).

$$Ii = a cos ( φ + δi ) + b \qquad Formula ( 1 )$$

Ii represents a luminance value in the i-th captured image. a represents a contrast component. b represents an offset component. Sδi represents a phase shift amount corresponding to the i-th captured image. φ represents a phase.

In the formula (1), unknowns are a, b, and φ. Therefore, the processor 31 can calculate a, b, and φ for each pixel by acquiring at least three captured images.

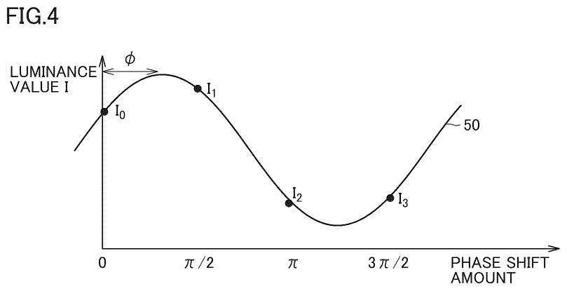

FIG. 4 is a diagram illustrating the luminance values and phase shift amounts of the pixels in the four captured images corresponding to the phase shift amounts of 0, π/2, π, and 3π/2. The processor 31 calculates the phase φ by specifying a cosine curve 50 that approximates to the luminance values and phase shift amounts of the four captured images.

To be specific, when I0 represents a luminance value in the captured image corresponding to the phase shift amount of 0, I1 represents a luminance value in the captured image corresponding to the phase shift amount of π/2, I2 represents a luminance value in the captured image corresponding to the phase shift amount of π, and I3 represents a luminance value in the captured image corresponding to the phase shift amount of 3π/2, the phase q is calculated in accordance with the following formula (2).

$$tan φ = - ( I 3 - I 1 ) / ( I 2 - I 0 ) \qquad Formula ( 2 )$$

The phase φ and height h of the measurement target 300 in the pixel satisfy the following formula (3).

$$h = ( p / sin α ) \times ( φ + 2 n π ) / 2 π \qquad Formula ( 3 )$$

p represents a pitch of the stripe pattern. a represents a projection angle of the stripe pattern. n represents an order. The processor 31 converts the phase φ into the height h in accordance with the formula (3) and generates three-dimensional point cloud data indicating the height h for each pixel.

The luminance value of each pixel as indicated by the captured image may include an error due to an influence of noise or the like of the camera 2. Hereinafter, the error included in the luminance value is referred to as a “luminance error”.

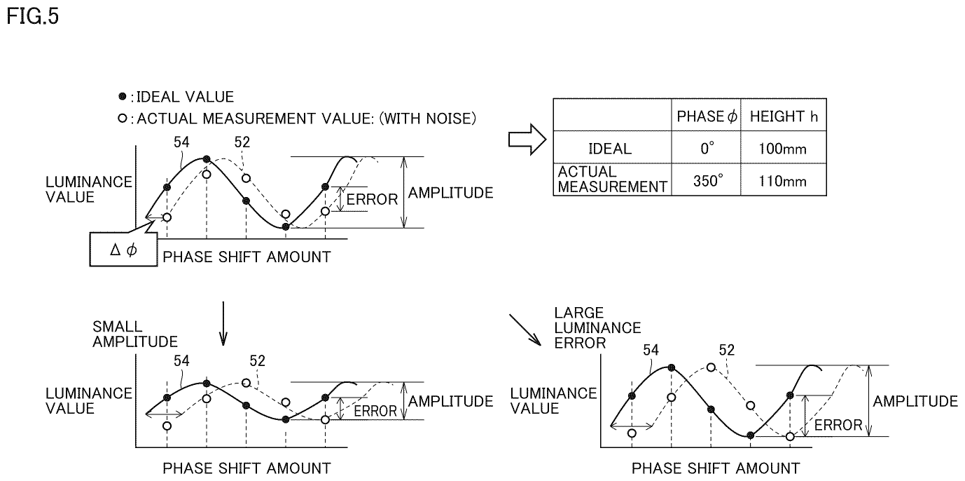

FIG. 5 is a diagram illustrating the influence of the luminance error over the three-dimensional shape measurement. In FIG. 5, a curve 52 is a cosine curve that approximates to the luminance values and phase shift amounts in the plurality of captured images. The curve 52 is specified using the luminance value including the luminance error. In FIG. 5, a curve 54 is a cosine curve that approximates to ideal luminance values including no luminance errors and phase shift amounts. As illustrated in FIG. 5, a phase error ΔΦ is generated between the curve 52 and the curve 54 due to the influence of the luminance error. That is, the phase φ calculated from the curve 52 includes the phase error Δφ.

Due to the influence of the phase error Δφ, an error is also generated in the height h converted from the phase φ. In the example illustrated in FIG. 5, a phase error Δφ of 10° is included, with the result that an error of 10 mm is included in the height h converted from the phase φ. In this way, the error is also generated in the height h due to the influence of the luminance error.

As the luminance error is increased, the phase error Δφ is increased. As a result, the error included in the height h converted from the phase φ is also increased.

Further, if the amplitude of the luminance value when the phase shift amount is changed is small, the influence of the luminance error becomes relatively large. As a result, the phase error Δφ is increased to result in an increased error included in the height h converted from the phase φ. Hereinafter, the error of the height h is also referred to as a “measurement error”.

The amplitude of the luminance value when the phase shift amount is changed is correlated with the contrast of the stripe pattern in the captured image. If the contrast of the stripe pattern in the captured image is decreased, the amplitude of the luminance value when the phase shift amount is changed is decreased. The contrast of the stripe pattern in the captured image depends on a degree of focus of the projection optical system 13 on the measurement target 300 and a degree of focus of the light-collection optical system 22 on the measurement target 300.

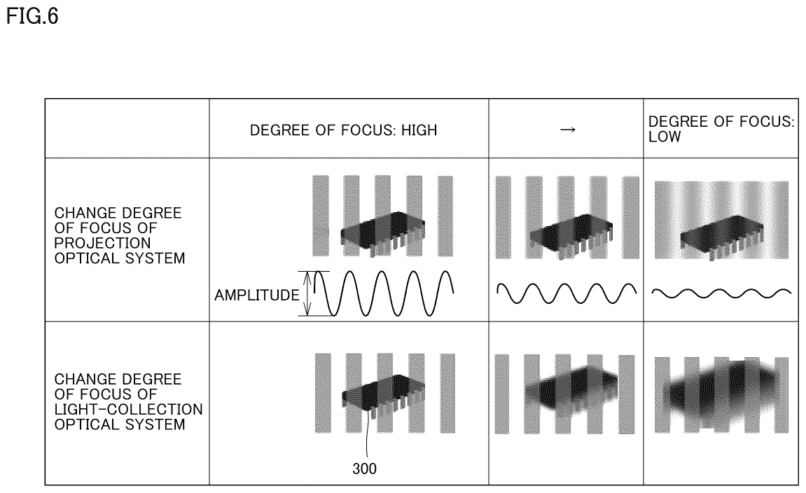

FIG. 6 is a diagram illustrating an exemplary captured image when the degrees of focus of the projection optical system and the light-collection optical system on the measurement target are changed. The upper part of FIG. 6 illustrates three captured images when the degree of focus of the projection optical system 13 on the measurement target 300 is changed while maintaining a state in which the focus of the light-collection optical system 22 is on the measurement target 300. The lower part of FIG. 6 illustrates three captured images when the degree of focus of the light-collection optical system 22 on the measurement target 300 is changed while maintaining a state in which the focus of the projection optical system 13 is on the measurement target 300.

As illustrated in the lower part of FIG. 6, the contrasts of both the stripe pattern and the measurement target 300 are decreased when the degree of focus of the light-collection optical system 22 is low in the state in which the focus of the projection optical system 13 is on the measurement target 300. Therefore, when the degree of focus of the light-collection optical system 22 is low, measurement accuracy for the height h of the measurement target 300 can be greatly decreased. Therefore, as described above, the camera 2 of the present embodiment is adjusted by the auto-focus mechanism 23 so as to bring the measurement target 300 into focus. Thus, the measurement accuracy is suppressed from being decreased due to the decrease in the degree of focus of the light-collection optical system 22 on the measurement target 300.

As illustrated in the upper part of FIG. 6, when the degree of focus of the projection optical system 13 is low in a state in which the focus of the light-collection optical system 22 is on the measurement target 300, the contrast of the measurement target 300 is not decreased, but the contrast of the stripe pattern is decreased. By applying the auto-focus mechanism also to the projection optical system 13, the contrast of the stripe pattern is prevented from being decreased. Alternatively, the decrease in contrast of the stripe pattern is prevented also by applying to the projection optical system 13, parallel light disclosed in Japanese Laid-Open Patent Publication No. 2018-146521. However, when applying the auto-focus mechanism to the projection optical system 13, the measurement time is increased. Also, when the configuration disclosed in Japanese Laid-Open Patent Publication No. 2018-146521 is applied to the projection optical system 13, since parallel light is subjected to raster scanning, it takes a long measurement time to perform measurement in a wide range. Therefore, in the three-dimensional shape measurement apparatus 100 according to the present embodiment, the focal length of the projection optical system 13 is set to be fixed, and the cycle L of the stripe pattern is changed to reduce the influence of the decrease in contrast of the stripe pattern as small as possible. Thus, the measurement time is suppressed from being increased as compared with the case where the auto-focus mechanism or the configuration disclosed in Japanese Laid-Open Patent Publication No. 2018-146521 is applied to the projection optical system 13.

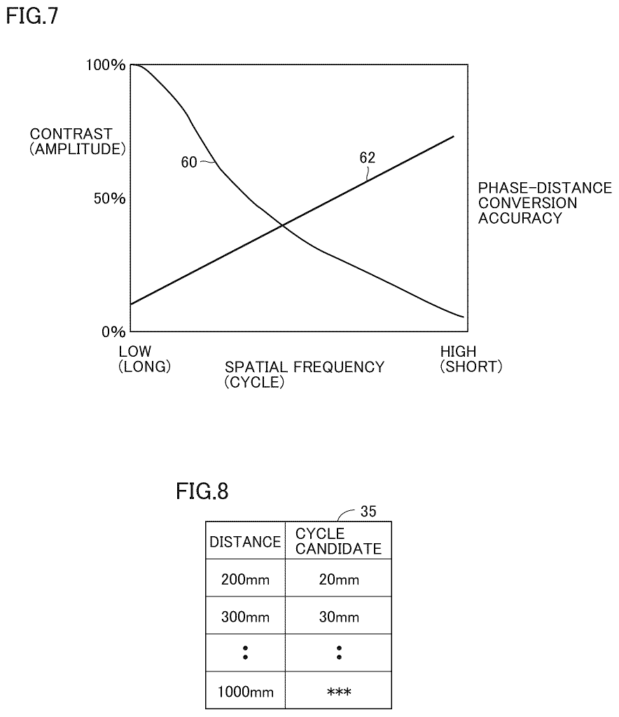

FIG. 7 is a diagram illustrating changes in the contrast of the stripe pattern in the captured image and the conversion accuracy from the phase φ to the height h with respect to a spatial frequency of the stripe pattern. In FIG. 7, a line 60 represents a change in contrast of the stripe pattern in the captured image with respect to the spatial frequency of the stripe pattern. The line 60 represents a modulation transfer function (MTF) characteristic. A line 62 represents a change in conversion accuracy from the phase φ to the height h with respect to the spatial frequency of the stripe pattern.

As illustrated in FIG. 7, generally, as the spatial frequency of the stripe pattern is higher, the contrast is decreased. In other words, as the cycle L of the stripe pattern is shorter, the contrast is decreased. Further, as the spatial frequency of the stripe pattern is higher, the conversion accuracy from the phase φ to the height h is higher. In other words, as the cycle L of the stripe pattern is shorter, the conversion accuracy from the phase φ to the height h is higher. This is because the coefficient of the pitch p of the stripe pattern is present on the right side of the above-described formula (3) used for the conversion from the phase φ to the height h.

In view of the characteristics illustrated in FIG. 7, the decrease in the contrast of the stripe pattern in the captured image is caused in response to the decrease in the degree of focus of the projection optical system 13 on the measurement target 300 and is suppressed by making the cycle L of the stripe pattern long. However, when the cycle L of the stripe pattern is made too long, the conversion accuracy from the phase φ to the height h is decreased, thus resulting in decreased measurement accuracy of the three-dimensional shape. Therefore, in the three-dimensional shape measurement apparatus 100 according to the present embodiment, the cycle L of the stripe pattern is set such that the error (measurement error) of the height h becomes as small as possible in consideration of both the decrease in contrast of the stripe pattern in the captured image and the conversion accuracy from the phase φ to the height h.

### <Table>

FIG. 8 is a diagram illustrating an exemplary table. As illustrated in FIG. 8, the table 35 associates each of a plurality of distances between the measurement target and the projector 1 with a cycle candidate. The cycle candidate represents a cycle of the stripe pattern generated in the light modulation apparatus 12 (for example, the stripe pattern on the DMD). The cycle candidate is set in advance to attain the smallest measurement error when the three-dimensional shape of the measurement target 300 at the position away from the projector 1 by the corresponding distance is measured. Hereinafter, first to third setting methods for the cycle candidate will be described.

### (First Setting Method)

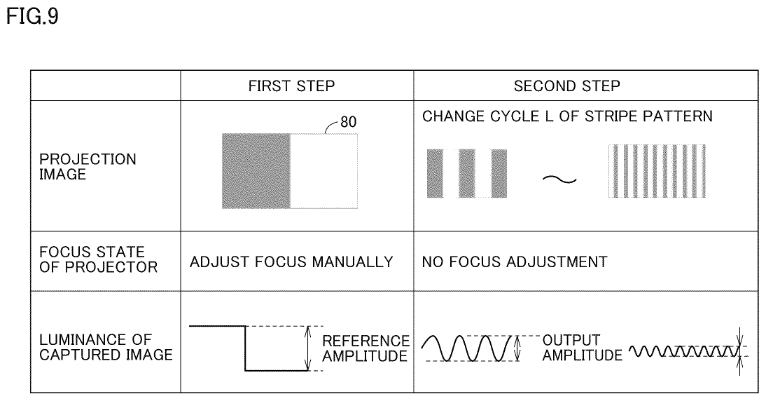

FIG. 9 is a diagram illustrating the first setting method for the cycle candidate. When setting a cycle candidate corresponding to a target distance of the plurality of distances, an object prepared for setting of the table 35 is placed at a position away from the projector 1 by the target distance.

In a first step of the first setting method, the projection optical system 13 is adjusted to bring the object into focus. As described above, the projector 1 has a fixed focal length. Therefore, the adjustment of the focus of the projection optical system 13 is manually performed. For example, the user may adjust the focus of the projection optical system 13 by changing the position or lens type of the projection optical system 13.

Next, the processor 31 controls the projector 1 to project a binary image 80 with the focus of the projection optical system 13 being on the object. The binary image 80 includes a dark region and a bright region. The luminance is uniform in each of the dark region and the bright region.

The processor 31 acquires a first reference image captured by the camera 2 when the binary image 80 is projected from the projector 1 with the focus being on the object. The first reference image is an exemplary “second image”. The processor 31 calculates the amplitude of the luminance in the first reference image (hereinafter, referred to as a “reference amplitude”).

In a second step of the first setting method, the user returns the focus of the projection optical system 13 to the default state. Thus, the projector 1 is returned to the state in which the projector 1 has the fixed focal length. The processor 31 controls the projector 1 to sequentially project a plurality of stripe patterns having different cycles L. Further, the processor 31 acquires a captured image captured by the camera 2 when each stripe pattern is projected on the object placed at the position away from the projector 1 by the target distance. The captured image is an exemplary first image. The processor 31 calculates the amplitude of the luminance in each captured image. Hereinafter, the amplitude of the luminance of the captured image is also referred to as the “amplitude of the captured image”.

The processor 31 determines a cycle range of the stripe pattern in which the amplitude of the captured image is 50% or more of the reference amplitude. The processor 31 sets the shortest cycle in the determined cycle range as the cycle candidate corresponding to the target distance.

In this way, the cycle candidates are set for all of the plurality of distances. As described with reference to FIG. 6, when the degree of focus of the projection optical system 13 on the object is decreased, the contrast of the stripe pattern is decreased in the captured image. That is, as a difference between the target distance of the plurality of distances and the focal length of the projector 1 is increased, the contrast of the stripe pattern is decreased in the captured image. As described with reference to FIG. 7, the decrease in contrast due to the decrease in the degree of focus of the projection optical system 13 on the object is suppressed by making the cycle L of the stripe pattern long. However, when the cycle L is made too long, the conversion accuracy from the phase φ to the height h is decreased, and therefore the shortest cycle in the cycle range of the stripe pattern in which the amplitude of the captured image is 50% or more of the reference amplitude is set as the cycle candidate. The cycle range of the stripe pattern in which the amplitude of the captured image is 50% or more of the reference amplitude is shifted in a direction in which the cycle is longer as the difference between the target distance and the focal length of the projector 1 is increased. Therefore, in the table 35, as the difference between the corresponding distance and the focal length is larger, the cycle candidate is longer.

### (Second Setting Method)

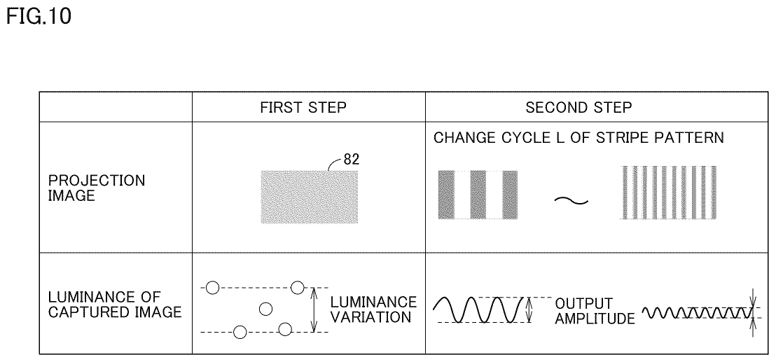

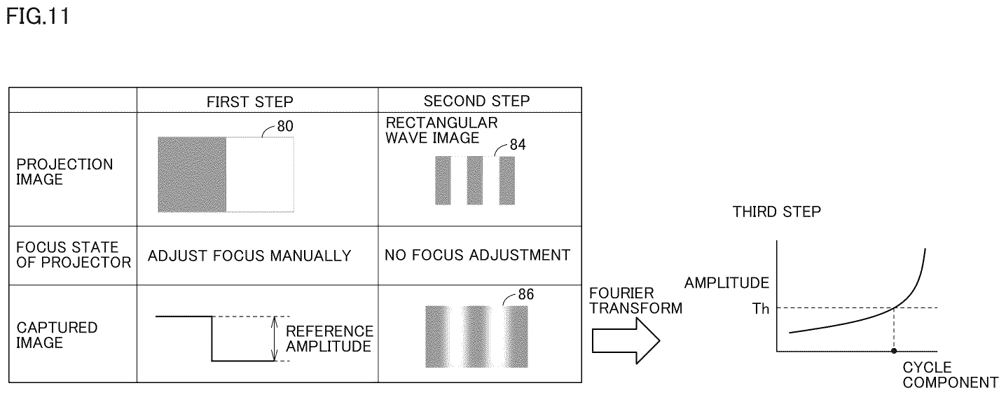

FIG. 10 is a diagram illustrating the second setting method for the cycle candidate. As with the first setting method, when setting a cycle candidate corresponding to a target distance of the plurality of distances, an object prepared for setting of the table 35 is placed at a position away from the projector 1 by the target distance.

In a first step of the second setting method, the processor 31 controls the projector 1 to project a uniform pattern 82. The uniform pattern 82 is a pattern in which the luminance is entirely uniform. The processor 31 acquires a second reference image captured by the camera 2 when the uniform pattern 82 is projected. The second reference image is an exemplary “second image”. The processor 31 calculates a luminance variation in the second reference image. The luminance variation is represented by, for example, a difference between a minimum luminance value and a maximum luminance value. The luminance variation is also referred to as noise.

In a second step of the second setting method, the processor 31 controls the projector 1 to sequentially project a plurality of stripe patterns having different cycles L. Further, the processor 31 acquires a captured image captured by the camera 2 when each stripe pattern is projected on the object placed at the position away from the projector 1 by the target distance. The captured image is an exemplary first image. The processor 31 calculates the amplitude of the luminance of each captured image. Hereinafter, the amplitude of the luminance of the captured image is also referred to as the “amplitude of the captured image”.

The processor 31 determines a cycle range of the stripe pattern in which the amplitude of the captured image is 10 times or more as large as the luminance variation. The processor 31 sets the shortest cycle in the determined cycle range as the cycle candidate corresponding to the target distance.

As described with reference to FIG. 5, when the contrast of the stripe pattern is decreased in the captured image, the influence of the luminance error becomes relatively large. The luminance variation calculated in the first step is proportional to the luminance error. Therefore, by determining the cycle range of the stripe pattern in which the amplitude of the captured image is 10 times or more as large as the luminance variation, a degree of influence of the luminance error over the contrast of the stripe pattern of the cycle within the determined cycle range is decreased. However, when the cycle L is made too long, conversion accuracy from the phase φ to the height h is decreased, and therefore the shortest cycle in the cycle range is set as the cycle candidate.

As described with reference to FIG. 6, when the degree of focus of the projection optical system 13 on the object is decreased, the contrast of the stripe pattern is decreased in the captured image. That is, as a difference between the target distance of the plurality of distances and the focal length of the projector 1 is increased, the contrast of the stripe pattern is decreased in the captured image. However, as described with reference to FIG. 7, the decrease in contrast due to the decrease in the degree of focus of the projection optical system 13 on the object is suppressed by making the cycle L of the stripe pattern long. Therefore, the cycle range of the stripe pattern in which the amplitude of the captured image is 10 times or more as large as the luminance variation is shifted in a direction in which the cycle becomes longer as the difference between the target distance and the focal length of the projector 1 is increased. Therefore, in the table 35, as the difference between the corresponding distance and the focal length is larger, the cycle candidate is longer.

### (Third Setting Method)

FIG. 11 is a diagram illustrating the third setting method for the cycle candidate. As with the first setting method, when setting a cycle candidate corresponding to a target distance of the plurality of distances, an object prepared for setting of the table 35 is placed at a position away from the projector 1 by the target distance.

A first step of the third setting method is the same as the first step of the first setting method. When the first step is performed, the processor 31 calculates the reference amplitude.

In a second step of the third setting method, the user returns the focus of the projection optical system 13 to the default state. Thus, the projector 1 is returned to the state in which the projector I has the fixed focal length. Thereafter, the processor 31 controls the projector 1 to project a rectangular wave pattern 84. The rectangular wave pattern 84 is a pattern in which a dark region and a bright region are alternately repeated. The luminance is uniform in each of the dark region and the bright region.

The processor 31 acquires a captured image 86 captured by the camera 2 when the rectangular wave pattern 84 is projected on the object placed at the position away from the projector 1 by the target distance. The captured image 86 is an exemplary “first image”.

In a third step of the third setting method, the processor 31 performs a Fourier transform on the captured image 86. By performing the Fourier transform on the captured image 86, a correlation between a cycle component and an amplitude is obtained. The correlation between the cycle component and the amplitude corresponds to a correlation between the cycle L of the stripe pattern and the amplitude. The correlation between the cycle L of the stripe pattern and the amplitude is obtained by the second step of the first setting method, and therefore, the processor 31 determines, in accordance with the correlation between the cycle component and the amplitude, a cycle component range corresponding to an amplitude of 50% (threshold value Th) or more of the reference amplitude. The processor 31 sets the shortest cycle component in the determined cycle range as the cycle candidate.

In this way, the cycle candidates are set for all of the plurality of distances. According to the third setting method, the shortest cycle component in the cycle component range in which the amplitude is 50% or more of the reference amplitude is set as the cycle candidate. As with the first setting method, the cycle component range in which the amplitude is 50% or more of the reference amplitude is shifted in a direction in which the cycle component becomes longer as the difference between the target distance and the focal length of the projector 1 is increased. Therefore, in the table 35, as the difference between the corresponding distance and the focal length is larger, the cycle candidate is longer.

According to the third setting method, it is not necessary to sequentially project a plurality of stripe patterns having different cycles L. Therefore, in the third setting method, the table 35 can be created by a smaller number of steps than those in the first setting method.

### <Method of Controlling Projector>

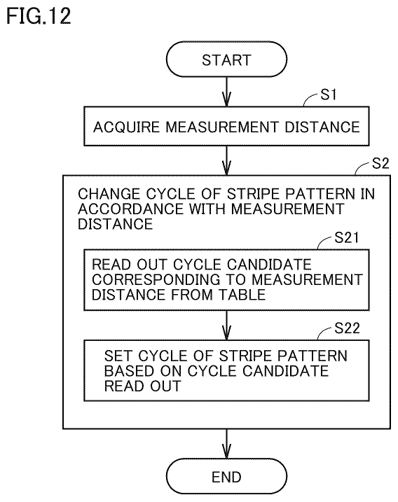

A method of controlling the projector 1 by the processor 31 includes a step of creating the table 35 in accordance with one of the first to third setting methods described above. The table 35 is created. After the table 35 is created, the processor 31 controls the projector 1 in accordance with a flowchart illustrated in FIG. 12.

FIG. 12 is a flowchart illustrating a flow of the method of controlling the projector by the processor. In a step S1, the processor 31 acquires a measurement distance from the distance measurement device 4. In the next step S2, the processor 31 changes, in accordance with the measurement distance, the cycle L of the stripe pattern that is projected by the projector 1 and that is in the form of a sinusoidal wave.

The step S2 includes steps S21 and S22. In the step S21, the processor 31 reads out a cycle candidate corresponding to the measurement distance from the table 35 in which each of the plurality of distances between the measurement target and the projector 1 is associated with a cycle candidate. In the next step S22, the processor 31 sets the cycle L of the stripe pattern based on the cycle candidate read out.

For example, when a distance for which a difference between the distance and the measurement distance falls within a defined range is present in the table 35, the processor 31 reads out a cycle candidate corresponding to the distance and sets the read cycle candidate as the cycle L of the stripe pattern. When the distance for which the difference between the distance and the measurement distance falls within the defined range is not present in the table 35, the processor 31 reads two cycle candidates corresponding to two distances for each of which a difference between the distance and the measurement distance is relatively small and sets the cycle L of the stripe pattern by interpolation calculation using the two read cycle candidates.

### <Modification Example 1>

In each of the first setting method and the second setting method, the captured image obtained from the camera 2 is used. However, in each of the first setting method and the second setting method, instead of the captured image, the cycle candidate may be set based on a luminance value of a projection image at a position away by a corresponding distance.

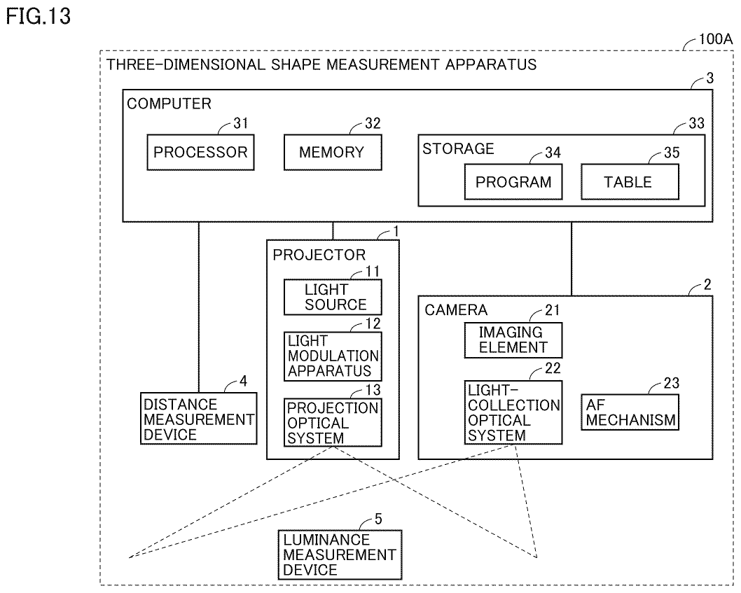

FIG. 13 is a diagram illustrating a hardware configuration of a three-dimensional shape measurement apparatus according to a modification example 1. A three-dimensional shape measurement apparatus 100A according to the modification example 1 is different from the three-dimensional shape measurement apparatus 100 in that a luminance measurement device 5 is provided.

The luminance measurement device 5 measures a luminance of incoming light. The luminance measurement device 5 is movable to change a distance from the projector 1. The luminance measurement device 5 includes, for example, a photodiode, an optical power meter, or the like.

### (First Setting Method According to Modification Example 1)

In a first setting method according to the modification example 1, the luminance measurement device 5 is installed at a position away from the projector 1 by a target distance.

In a first step of the first setting method according to the modification example 1, the projection optical system 13 is adjusted to bring the luminance measurement device 5 into focus. Next, with the focus of the projection optical system 13 being on the luminance measurement device 5, the processor 31 controls the projector 1 to project a binary image 80 while moving the binary image 80.

The processor 31 calculates, as a reference amplitude, the amplitude of the luminance measured by the luminance measurement device 5 when the binary image 80 is projected while being moved with the focus thereof being on the luminance measurement device 5.

In a second step of the first setting method according to the modification example 1, the user returns the focus of the projection optical system 13 to the default state. Thus, the projector 1 is returned to the state in which the projector 1 has the fixed focal length. The processor 31 controls the projector 1 to sequentially project a plurality of stripe patterns having different cycles L. Further, the processor 31 calculates the amplitude of the luminance measured by the luminance measurement device 5 when each stripe pattern is projected, while being moved on the luminance measurement device 5 placed at the position away from the projector 1 by the target distance.

The processor 31 determines a cycle range of stripe pattern in which the amplitude is 50% or more of the reference amplitude. The processor 31 sets the shortest cycle in the determined cycle range as the cycle candidate corresponding to the target distance.

Also by the first setting method according to the modification example 1, the cycle range of the stripe pattern in which the amplitude is 50% or more of the reference amplitude is shifted in a direction in which the cycle is longer as the difference between the target distance and the focal length of the projector 1 is increased. Therefore, in the table 35, as the difference between the corresponding distance and the focal length is larger, the cycle candidate is longer.

### (Second Setting Method According to Modification Example 1)

In a second setting method according to the modification example 1, the luminance measurement device 5 is installed at a position away from the projector 1 by a target distance.

In a first step of the second setting method according to the modification example 1, the processor 31 controls the projector 1 to project a uniform pattern 82 while moving the uniform pattern 82. The processor 31 calculates a luminance variation measured by the luminance measurement device 5 when the uniform pattern is projected while being moved.

In a second step of the second setting method according to the modification example 1, the processor 31 controls the projector 1 to sequentially project a plurality of stripe patterns having different cycles L while being moved. Further, the processor 31 calculates the amplitude of the luminance measured by the luminance measurement device 5 when each stripe pattern is projected, while being moved on the luminance measurement device 5 placed at the position away from the projector 1 by the target distance.

The processor 31 determines a cycle range of stripe pattern in which the amplitude of the luminance is 10 times or more as large as the luminance variation. The processor 31 sets the shortest cycle in the determined cycle range as the cycle candidate corresponding to the target distance.

Also by the second setting method according to the modification example 1, the cycle range of the stripe pattern in which the amplitude of the luminance is 10 times or more as large as the luminance variation is shifted in a direction in which the cycle is longer as the difference between the target distance and the focal length of the projector 1 is increased. Therefore, in the table 35, as the difference between the corresponding distance and the focal length is larger, the cycle candidate is longer.

In the three-dimensional shape measurement apparatus 100A according to the modification example 1, when setting a cycle candidate in the table 35, it is not necessary to extract a luminance from an image captured by the camera 2. Therefore, the number of steps is reduced.

### <Modification Example 2>

In the above description, the three-dimensional shape measurement apparatus 100 uses the camera 2 including the auto-focus mechanism 23. However, the three-dimensional shape measurement apparatus is not limited to the configuration provided with the camera 2 including the auto-focus mechanism 23.

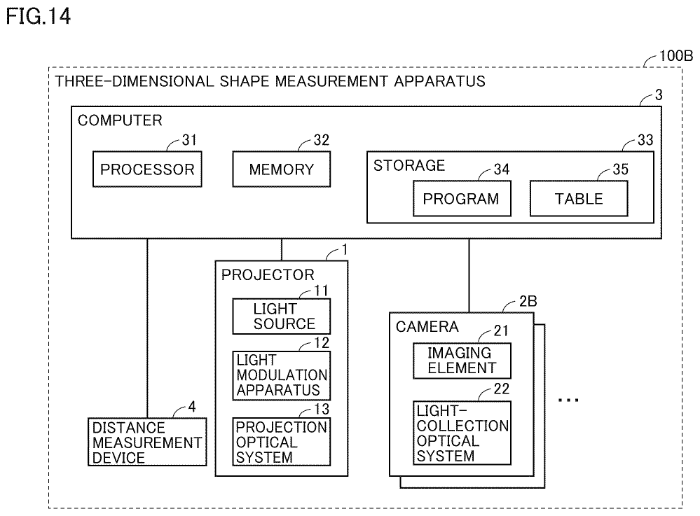

FIG. 14 is a diagram illustrating a hardware configuration of a three-dimensional shape measurement apparatus according to a modification example 2. A three-dimensional shape measurement apparatus 100B according to the modification example 2 is different from the three-dimensional shape measurement apparatus 100 in that a plurality of cameras 2B are provided instead of the camera 2.

Each of the plurality of cameras 2B is different from camera 2 in that each of the plurality of cameras 2B does not include the auto-focus mechanism 23. That is, each of the plurality of cameras 2B has a fixed focal length. It should be noted that the focal lengths of the plurality of cameras 2B are different from one another.

The processor 31 selects a specific camera having the highest degree of focus on the measurement target 300 among the plurality of cameras 2B and measures a three-dimensional shape using an image captured by the specific camera. To be specific, the processor 31 may select, as the specific camera, the camera 2B having a focal distance closest to the measurement distance acquired from the distance measurement device 4. Thus, the camera 2B adjusted to bring the measurement target 300 into focus is used.

### <Modification Example 3>

The three-dimensional shape measurement apparatus may not include the distance measurement device 4. In this case, the processor 31 may use the principle of the phase shift method to measure the distance (measurement distance) between the projector 1 and the measurement target 300 based on a plurality of captured images obtained from the camera 2 when a plurality of stripe patterns having different phases are projected on the measurement target 300. That is, the processor 31 operates as a distance measurement section that measures the distance between the measurement target 300 and the projector 1. Thus, cost required for the distance measurement device 4 can be reduced.

Note that since the measurement distance is unknown, the processor 31 causes the projector 1 to project a stripe pattern having a default cycle. Accuracy of the measurement distance is low because there is a high possibility that the cycle does not correspond to the distance to the measurement target 300. However, by changing the cycle L of the stripe pattern in accordance with the measurement distance, measurement accuracy of the three-dimensional shape is increased as compared with a case where the stripe pattern having the default cycle is used.

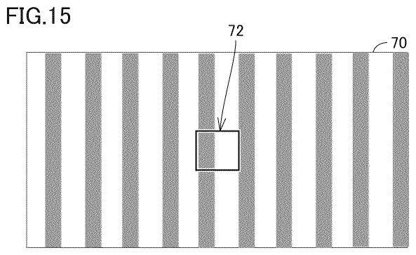

FIG. 15 is a diagram illustrating an exemplary captured image. The processor 31 may calculate the measurement distance by using a partial range 72 in a captured image 70, the partial range 72 including a pixel representing the luminance of the optical axis of the projector 1. The partial range 72 has a length corresponding to one cycle of the stripe pattern.

Light farther away from the optical axis of the projector 1 is more likely to be affected by lens distortion. Therefore, by calculating the measurement distance using the partial range 72 including the pixel representing the luminance of the optical axis, the accuracy of the measurement distance is improved.

### <Modification Example 4>

The stripe pattern is not limited to the form of a sinusoidal wave. For example, the stripe pattern may be a pattern obtained by combining a plurality of sinusoidal waves, a pattern in the form of a sinusoidal wave with its frequency being partially changed, or a pattern in the form of a staircase wave.

### <Supplementary Notes>

As described above, the present embodiment includes the following disclosure.

### [Configuration 1]

A three-dimensional shape measurement apparatus comprising:
a camera adjusted to bring a measurement target into focus; and
a projector that projects a stripe pattern, wherein
a cycle of the stripe pattern projected by the projector is variable.

### [Configuration 2]

The three-dimensional shape measurement apparatus according to configuration 1, wherein the cycle of the stripe pattern is set in accordance with a measurement distance between the measurement target and the projector.

### [Configuration 3]

The three-dimensional shape measurement apparatus according to configuration 2, wherein the cycle of the stripe pattern is set based on a table in which each of a plurality of distances between the measurement target and the projector is associated with a cycle candidate.

### [Configuration 4]

The three-dimensional shape measurement apparatus according to configuration 3, wherein
the projector has a fixed focal length, and
in the table,
   the cycle candidate is set such that an amplitude of a first image captured by the camera when the stripe pattern is projected on an object placed at a position away from the projector by a corresponding distance of the plurality of distances is 50% or more of an amplitude of a second image captured by the camera when a binary image in focus on the object is projected, and
   as a difference between the corresponding distance and the focal length is larger, the cycle candidate is longer.

### [Configuration 5]

The three-dimensional shape measurement apparatus according to configuration 3, wherein
the projector has a fixed focal length, and
in the table,
   the cycle candidate is set such that an amplitude of a first image captured by the camera when the stripe pattern is projected on an object placed at a position away from the projector by a corresponding distance of the plurality of distances is 10 times or more as large as a luminance variation of a second image captured by the camera when a uniform pattern is projected on the object, and
   as a difference between the corresponding distance and the focal length is larger, the cycle candidate is longer.

### [Configuration 6]

The three-dimensional shape measurement apparatus according to configuration 3, wherein
the projector has a fixed focal length, and
in the table,
   in a correlation between a cycle component and an amplitude as obtained by performing Fourier transform on a first image captured by the camera when a rectangular wave pattern is projected on an object placed at a position away from the projector by a corresponding distance of the plurality of distances, the cycle candidate is set to a cycle component corresponding to 50% or more of an amplitude of a second image captured by the camera when a binary image in focus on the object is projected, and
   as a difference between the corresponding distance and the focal length is larger, the cycle candidate is longer.

### [Configuration 7]

The three-dimensional shape measurement apparatus according to configuration 3, wherein
the projector has a fixed focal length, and
in the table,
   the cycle candidate is set such that an amplitude of a first luminance measured by a luminance measurement device placed at a position away from the projector by a corresponding distance of the plurality of distances when the stripe pattern is projected, while being moved, on the luminance measurement device is 50% or more of an amplitude of a second luminance measured by the luminance measurement device when a binary image in focus on the luminance measurement device is projected while being moved, and
   as a difference between the corresponding distance and the focal length is larger, the cycle candidate is longer.

### [Configuration 8]

The three-dimensional shape measurement apparatus according to configuration 3, wherein
the projector has a fixed focal length, and
in the table,
   the cycle candidate is set such that an amplitude of a first luminance measured by a luminance measurement device placed at a position away from the three-dimensional shape measurement apparatus by a corresponding distance of the plurality of distances when the stripe pattern is projected, while being moved, on the luminance measurement device is 10 times or more as large as a variation of a second luminance measured by the luminance measurement device when a uniform pattern is projected, while being moved, on the luminance measurement device, and
as a difference between the corresponding distance and the focal length is larger, the cycle candidate is longer.

### [Configuration 9]

The three-dimensional shape measurement apparatus according to any one of configurations 2 to 7, further comprising a distance measurement device that measures the measurement distance.

### [Configuration 10]

The three-dimensional shape measurement apparatus according to configuration 9, wherein
the distance measurement device measures, as the measurement distance, a distance between a partial range of the measurement target and the projector, and
the partial range has a length corresponding to one cycle of the stripe pattern projected on the measurement target.

### [Configuration 11]

The three-dimensional shape measurement apparatus according to any one of configurations 2 to 7, further comprising a distance measurement section that measures the measurement distance based on a plurality of images obtained from the camera when a plurality of stripe patterns having different phases are projected on the measurement target.

### [Configuration 12]

The three-dimensional shape measurement apparatus according to configuration 11, wherein
the distance measurement section measures the measurement distance using a partial range of each of the plurality of images, the partial range including a pixel representing a luminance of an optical axis of the projector, and
the partial range has a length corresponding to one cycle of the stripe pattern projected on the measurement target.

### [Configuration 13]

The three-dimensional shape measurement apparatus according to any one of configurations 1 to 12, wherein the camera has an auto-focus mechanism, and is adjusted by the auto-focus mechanism to bring the measurement target into focus.

### [Configuration 14]

The three-dimensional shape measurement apparatus according to any one of configurations 1 to 12, comprising a plurality of cameras having different focal lengths, wherein a specific camera having a highest degree of focus on the measurement target among the plurality of cameras is selected as the camera.

### [Configuration 15]

The three-dimensional shape measurement apparatus according to any one of configurations 1 to 14, wherein the stripe pattern is in a form of a sinusoidal wave.

### [Configuration 16]

A method of controlling a projector used for three-dimensional shape measurement, the method comprising:
acquiring a measurement distance between a measurement target and the projector; and
changing, in accordance with the measurement distance, a cycle of a stripe pattern projected by the projector.

### [Configuration 17]

The method according to configuration 16, wherein
the changing the cycle of the stripe pattern includes
   reading out a cycle candidate corresponding to the measurement distance, from a table in which each of a plurality of distances between the measurement target and the projector is associated with a cycle candidate, and
   setting the cycle of the stripe pattern based on the cycle candidate read out.

### [Configuration 18]

The method according to configuration 17, wherein the projector has a fixed focal length,
the method further comprising creating the table, wherein
for each of the plurality of distances, the creating the table includes
   determining a cycle range of the stripe pattern in which an amplitude of a first image captured by a camera used for the three-dimensional shape measurement when the stripe pattern is projected on an object placed at a position away from the projector by the distance is 50% or more of an amplitude of a second image captured by the camera when a binary image in focus on the object is projected, and setting a shortest cycle in the cycle range as the cycle candidate.

### [Configuration 19]

The method according to configuration 17, wherein the projector has a fixed focal length,
the method further comprising creating the table, wherein
for each of the plurality of distances, the creating the table includes
   determining a cycle range of the stripe pattern in which an amplitude of a first image captured by a camera used for the three-dimensional shape measurement when the stripe pattern is projected on an object placed at a position away from the projector by the distance is 10 times or more as large as a luminance variation of a second image captured by the camera when a uniform pattern is projected on the object, and
   setting a shortest cycle in the cycle range as the cycle candidate.

### [Configuration 20]

A program that causes a computer to perform the method according to any one of configurations 17 to 19.

Although embodiments of the present invention have been described and illustrated in detail, the disclosed embodiments are made for purposes of illustration and example only and not limitation. The scope of the present invention should be interpreted by terms of the appended claims.

What is claimed is:

1. A three-dimensional shape measurement apparatus comprising:
a camera adjusted to bring a measurement target into focus; and
a projector that projects a stripe pattern, wherein
a cycle of the stripe pattern projected by the projector is variable.

2. The three-dimensional shape measurement apparatus according to claim 1, wherein the cycle of the stripe pattern is set in accordance with a measurement distance between the measurement target and the projector.

3. The three-dimensional shape measurement apparatus according to claim 2, wherein the cycle of the stripe pattern is set based on a table in which each of a plurality of distances between the measurement target and the projector is associated with a cycle candidate.

4. The three-dimensional shape measurement apparatus according to claim 3, wherein
the projector has a fixed focal length, and
in the table,
the cycle candidate is set such that an amplitude of a first image captured by the camera when the stripe pattern is projected on an object placed at a position away from the projector by a corresponding distance of the plurality of distances is 50% or more of an amplitude of a second image captured by the camera when a binary image in focus on the object is projected, and
as a difference between the corresponding distance and the focal length is larger, the cycle candidate is longer.

5. The three-dimensional shape measurement apparatus according to claim 3, wherein
the projector has a fixed focal length, and
in the table,
the cycle candidate is set such that an amplitude of a first image captured by the camera when the stripe pattern is projected on an object placed at a position away from the projector by a corresponding distance of the plurality of distances is 10 times or more as large as a luminance variation of a second image captured by the camera when a uniform pattern is projected on the object, and
as a difference between the corresponding distance and the focal length is larger, the cycle candidate is longer.

6. The three-dimensional shape measurement apparatus according to claim 3, wherein
the projector has a fixed focal length, and
in the table,
in a correlation between a cycle component and an amplitude as obtained by performing Fourier transform on a first image captured by the camera when a rectangular wave pattern is projected on an object placed at a position away from the projector by a corresponding distance of the plurality of distances, the cycle candidate is set to a cycle component corresponding to 50% or more of an amplitude of a second image captured by the camera when a binary image in focus on the object is projected, and
as a difference between the corresponding distance and the focal length is larger, the cycle candidate is longer.

7. The three-dimensional shape measurement apparatus according to claim 3, wherein
the projector has a fixed focal length, and
in the table,
the cycle candidate is set such that an amplitude of a first luminance measured by a luminance measurement device placed at a position away from the projector by a corresponding distance of the plurality of distances when the stripe pattern is projected, while being moved, on the luminance measurement device is 50% or more of an amplitude of a second luminance measured by the luminance measurement device when a binary image in focus on the luminance measurement device is projected while being moved, and
as a difference between the corresponding distance and the focal length is larger, the cycle candidate is longer.

8. The three-dimensional shape measurement apparatus according to claim 3, wherein
the projector has a fixed focal length, and
in the table,
the cycle candidate is set such that an amplitude of a first luminance measured by a luminance measurement device placed at a position away from the three-dimensional shape measurement apparatus by a corresponding distance of the plurality of distances when the stripe pattern is projected, while being moved, on the luminance measurement device is 10 times or more as large as a variation of a second luminance measured by the luminance measurement device when a uniform pattern is projected, while being moved, on the luminance measurement device, and
as a difference between the corresponding distance and the focal length is larger, the cycle candidate is longer.

9. The three-dimensional shape measurement apparatus according to claim 2, further comprising a distance measurement device that measures the measurement distance.

10. The three-dimensional shape measurement apparatus according to claim 9, wherein
the distance measurement device measures, as the measurement distance, a distance between a partial range of the measurement target and the projector, and
the partial range has a length corresponding to one cycle of the stripe pattern projected on the measurement target.

11. The three-dimensional shape measurement apparatus according to claim 2, further comprising a hardware processor that measures the measurement distance based on a plurality of images obtained from the camera when a plurality of stripe patterns having different phases are projected on the measurement target.

12. The three-dimensional shape measurement apparatus according to claim 11, wherein
the hardware processor measures the measurement distance using a partial range of each of the plurality of images, the partial range including a pixel representing a luminance of an optical axis of the projector, and
the partial range has a length corresponding to one cycle of the stripe pattern projected on the measurement target.

13. The three-dimensional shape measurement apparatus according to claim 1, wherein the camera has an auto-focus mechanism, and is adjusted by the auto-focus mechanism to bring the measurement target into focus.

14. The three-dimensional shape measurement apparatus according to claim 1, comprising a plurality of cameras having different focal lengths, wherein
a specific camera having a highest degree of focus on the measurement target among the plurality of cameras is selected as the camera.

15. The three-dimensional shape measurement apparatus according to claim 1, wherein the stripe pattern is in a form of a sinusoidal wave.

16. A method of controlling a projector used for three-dimensional shape measurement, the method comprising:
acquiring a measurement distance between a measurement target and the projector; and
changing, in accordance with the measurement distance, a cycle of a stripe pattern projected by the projector.

17. The method according to claim 16, wherein
the changing the cycle of the stripe pattern includes
reading out a cycle candidate corresponding to the measurement distance, from a table in which each of a plurality of distances between the measurement target and the projector is associated with a cycle candidate, and
setting the cycle of the stripe pattern based on the cycle candidate read out.

18. The method according to claim 17, wherein the projector has a fixed focal length,
the method further comprising creating the table, wherein
for each of the plurality of distances, the creating the table includes
determining a cycle range of the stripe pattern in which an amplitude of a first image captured by a camera used for the three-dimensional shape measurement when the stripe pattern is projected on an object placed at a position away from the projector by the distance is 50% or more of an amplitude of a second image captured by the camera when a binary image in focus on the object is projected, and
setting a shortest cycle in the cycle range as the cycle candidate.

19. The method according to claim 17, wherein the projector has a fixed focal length,
the method further comprising creating the table, wherein
for each of the plurality of distances, the creating the table includes
determining a cycle range of the stripe pattern in which an amplitude of a first image captured by a camera used for the three-dimensional shape measurement when the stripe pattern is projected on an object placed at a position away from the projector by the distance is 10 times or more as large as a luminance variation of a second image captured by the camera when a uniform pattern is projected on the object, and
setting a shortest cycle in the cycle range as the cycle candidate.

20. A non-transitory computer-readable recording medium storing a program that causes a computer to perform a method of controlling a projector used for three-dimensional shape measurement, the method comprising:
acquiring a measurement distance between a measurement target and the projector; and
changing, in accordance with the measurement distance, a cycle of a stripe pattern projected by the projector.
